(19) United States
(12) Patent Application Publication
(10) Pub. No.: US 2019/0213651 A1
(43) Pub. Date: Jul. 11, 2019

(54) ONLINE SOCIAL ACTIVITY-DRIVEN GROUP GIFTING

(71) Applicant: International Business Machines Corporation, Armonk, NY (US)

(72) Inventors: Lisa Seacat DeLuca, BALTIMORE, MD (US); Jeremy A. Greenberger, San Jose, CA (US); Kelley Anders, East New Market, MD (US); Jeremy R. Fox, Georgetown, TX (US)

(21) Appl. No.: 15/863,026

(22) Filed: Jan. 5, 2018

(51) Int. Cl. G06Q 30/06; G06Q 50/00; H04L 12/58; H04L 29/08; G06N 5/02

(52) U.S. Cl. CPC G06Q 30/0605; G06Q 50/01; G06N 5/02; H04L 67/306; H04L 51/32

(57) ABSTRACT

A cognitive online-gifting system allows multiple users of an online community to jointly gift a recipient user. When community members post responses to an initial posting of the recipient user, the gifting system performs cognitive sentiment analyses to infer emotional subtext from the initial posting and from each responsive posting. The system chooses a gifting user and a set of candidate contributing users as functions of the inferred emotions. The gifting user selects a gift and the system solicits contributions toward the gift from the candidate contributors. The gift is then automatically delivered to the recipient user in the name of those candidates who agreed to contribute. If other users continue to post responses to the initial posting, they will be allowed to contribute to additional gifts in a similar manner.

### BACKGROUND

The present invention relates in general to online gift-giving and in particular to a cognitive-computing mechanism that allows groups of social-media users to jointly gift another user.

Some online resources and social communities, such as Internet retailers, social-media services, e-commerce sites, cloud-computing platforms, and gifting Web sites, directly or indirectly allow users and community members to exchange gifts. These gifting mechanisms, however, are generally straightforward applications of existing product-purchase functions or reward-point features. They are relatively simple and inflexible because they don't take advantage of the unique characteristics of online communities.

For example, known online-gifting mechanisms cannot intelligently assemble a group of users who are likely to jointly select the same gift for a particular recipient. Nor can known mechanisms dynamically adjust the membership of such groups as a function of inferred attitudes or personalities of group members or as a function of the emotional content of communications between group members and the gift recipient.

### SUMMARY

An embodiment of the present invention is A cognitive online-gifting system allows multiple users of an online community to jointly gift a recipient user. When community members post responses to an initial posting of the recipient user, the gifting system performs cognitive sentiment analyses to infer emotional subtext from the initial posting and from each responsive posting. The system chooses a gifting user and a set of candidate contributing users as functions of the inferred emotions. The gifting user selects a gift and the system solicits contributions toward the gift from the candidate contributors. The gift is then automatically delivered to the recipient user in the name of those candidates who agreed to contribute. If other users continue to post responses to the initial posting, they will be allowed to contribute to additional gifts in a similar manner.

Another embodiment of the present invention is a method for online social activity-driven group gifting. A cognitive online-gifting system allows multiple users of an online community to jointly gift a recipient user. When community members post responses to an initial posting of the recipient user, the gifting system performs cognitive sentiment analyses to infer emotional subtext from the initial posting and from each responsive posting. The system chooses a gifting user and a set of candidate contributing users as functions of the inferred emotions. The gifting user selects a gift and the system solicits contributions toward the gift from the candidate contributors. The gift is then automatically delivered to the recipient user in the name of those candidates who agreed to contribute. If other users continue to post responses to the initial posting, they will be allowed to contribute to additional gifts in a similar manner.

Yet another embodiment of the present invention is a computer program product, which includes a computer-readable storage medium that stores a program to perform a method for online social activity-driven group gifting. A cognitive online-gifting system allows multiple users of an online community to jointly gift a recipient user. When community members post responses to an initial posting of the recipient user, the gifting system performs cognitive sentiment analyses to infer emotional subtext from the initial posting and from each responsive posting. The system chooses a gifting user and a set of candidate contributing users as functions of the inferred emotions. The gifting user selects a gift and the system solicits contributions toward the gift from the candidate contributors. The gift is then automatically delivered to the recipient user in the name of those candidates who agreed to contribute. If other users continue to post responses to the initial posting, they will be allowed to contribute to additional gifts in a similar manner.

### BRIEF DESCRIPTION OF THE DRAWINGS

FIG. 1 depicts a cloud computing environment according to an embodiment of the present invention.

FIG. 2 depicts abstraction model layers according to an embodiment of the present invention.

FIG. 3 shows the structure of a computer system and computer program code that may be used to implement a method for online social activity-driven group gifting in accordance with embodiments of the present invention.

FIG. 4 shows a high-level architecture of an embodiment of the present invention implemented on one or more social-media services or other distributed computing platforms.

FIG. 5 is a flow chart that illustrates steps of a method for online social activity-driven group gifting in accordance with embodiments of the present invention.

### DETAILED DESCRIPTION

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

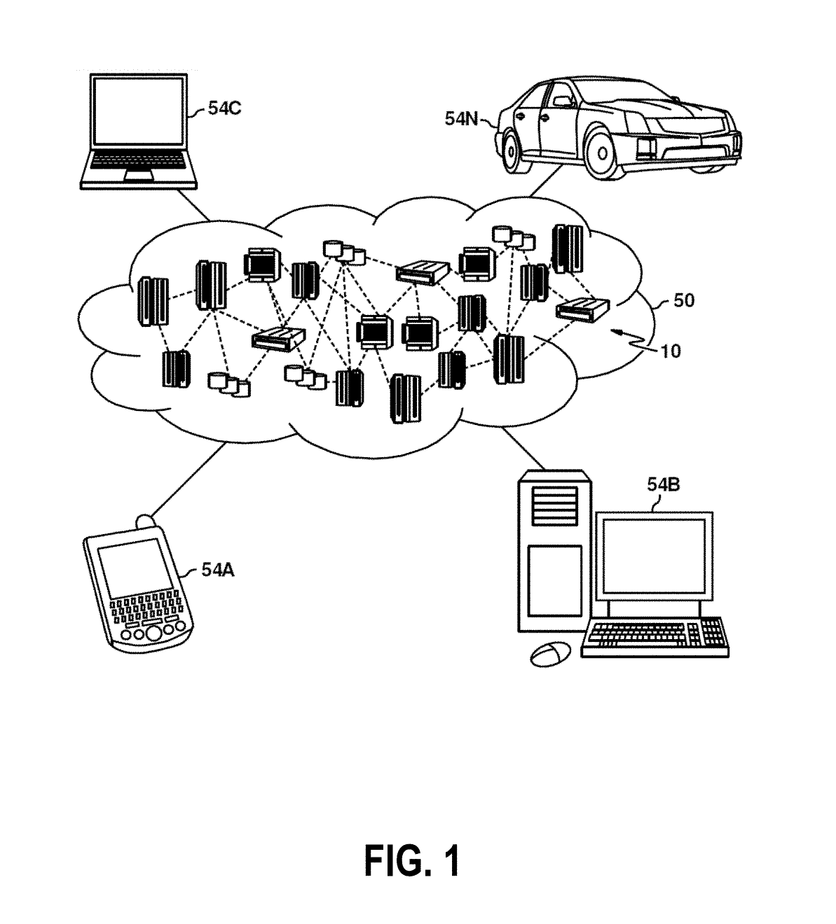

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

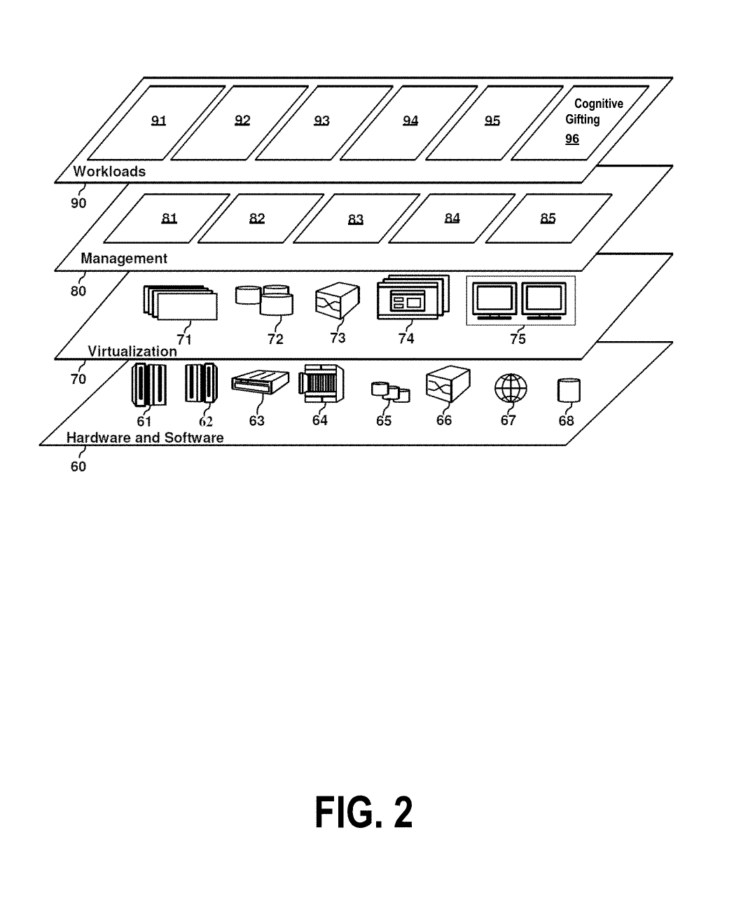

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93, data analytics processing 94; transaction processing 95; and online social activity-driven group gift-giving functionality 96.

Aspects of the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.”

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

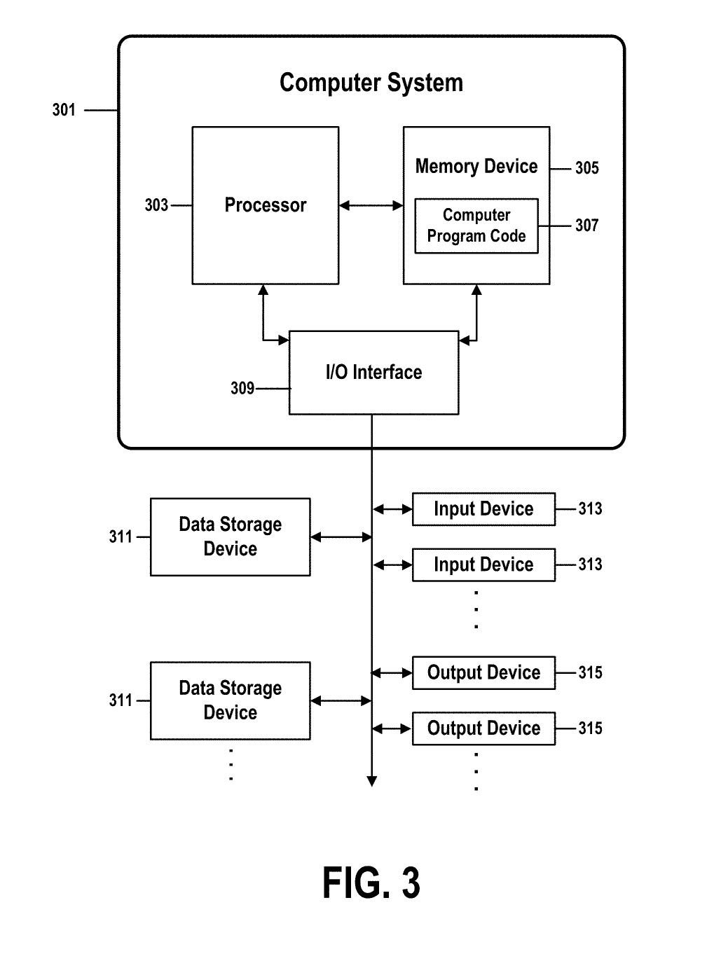

FIG. 3 shows a structure of a computer system and computer program code that may be used to implement a method for online social activity-driven group gifting in accordance with embodiments of the present invention. FIG. 3 refers to objects 301-315.

In FIG. 3, computer system 301 comprises a processor 303 coupled through one or more I/O Interfaces 309 to one or more hardware data storage devices 311 and one or more I/O devices 313 and 315.

Hardware data storage devices 311 may include, but are not limited to, magnetic tape drives, fixed or removable hard disks, optical discs, storage-equipped mobile devices, and solid-state random-access or read-only storage devices. I/O devices may comprise, but are not limited to: input devices 313, such as keyboards, scanners, handheld telecommunications devices, touch-sensitive displays, tablets, biometric readers, joysticks, trackballs, or computer mice; and output devices 315, which may comprise, but are not limited to printers, plotters, tablets, mobile telephones, displays, or sound-producing devices. Data storage devices 311, input devices 313, and output devices 315 may be located either locally or at remote sites from which they are connected to I/O Interface 309 through a network interface.

Processor 303 may also be connected to one or more memory devices 305, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 305 contains stored computer program code 307, which is a computer program that comprises computer-executable instructions. The stored computer program code includes a program that implements a method for online social activity-driven group gifting in accordance with embodiments of the present invention, and may implement other embodiments described in this specification, including the methods illustrated in FIGS. 1-5. The data storage devices 311 may store the computer program code 307. Computer program code 307 stored in the storage devices 311 is configured to be executed by processor 303 via the memory devices 305. Processor 303 executes the stored computer program code 307.

In some embodiments, rather than being stored and accessed from a hard drive, optical disc or other writeable, rewriteable, or removable hardware data-storage device 311, stored computer program code 307 may be stored on a static, nonremovable, read-only storage medium such as a Read-Only Memory (ROM) device 305, or may be accessed by processor 303 directly from such a static, nonremovable, read-only medium 305. Similarly, in some embodiments, stored computer program code 307 may be stored as computer-readable firmware 305, or may be accessed by processor 303 directly from such firmware 305, rather than from a more dynamic or removable hardware data-storage device 311, such as a hard drive or optical disc.

Thus the present invention discloses a process for supporting computer infrastructure, integrating, hosting, maintaining, and deploying computer-readable code into the computer system 301, wherein the code in combination with the computer system 301 is capable of performing a method for online social activity-driven group gifting.

Any of the components of the present invention could be created, integrated, hosted, maintained, deployed, managed, serviced, supported, etc. by a service provider who offers to facilitate a method for online social activity-driven group gifting. Thus the present invention discloses a process for deploying or integrating computing infrastructure, comprising integrating computer-readable code into the computer system 301, wherein the code in combination with the computer system 301 is capable of performing a method for online social activity-driven group gifting.

One or more data storage units 311 (or one or more additional memory devices not shown in FIG. 3) may be used as a computer-readable hardware storage device having a computer-readable program embodied therein and/or having other data stored therein, wherein the computer-readable program comprises stored computer program code 307. Generally, a computer program product (or, alternatively, an article of manufacture) of computer system 301 may comprise the computer-readable hardware storage device.

In embodiments that comprise components of a networked computing infrastructure, a cloud-computing environment, a client-server architecture, or other types of distributed platforms, functionality of the present invention may be implemented solely on a client or user device, may be implemented solely on a remote server or as a service of a cloud-computing platform, or may be split between local and remote components.

While it is understood that program code 307 for a method for online social activity-driven group gifting may be deployed by manually loading the program code 307 directly into client, server, and proxy computers (not shown) by loading the program code 307 into a computer-readable storage medium (e.g., computer data storage device 311), program code 307 may also be automatically or semi-automatically deployed into computer system 301 by sending program code 307 to a central server (e.g., computer system 301) or to a group of central servers. Program code 307 may then be downloaded into client computers (not shown) that will execute program code 307.

Alternatively, program code 307 may be sent directly to the client computer via e-mail. Program code 307 may then either be detached to a directory on the client computer or loaded into a directory on the client computer by an e-mail option that selects a program that detaches program code 307 into the directory.

Another alternative is to send program code 307 directly to a directory on the client computer hard drive. If proxy servers are configured, the process selects the proxy server code, determines on which computers to place the proxy servers' code, transmits the proxy server code, and then installs the proxy server code on the proxy computer. Program code 307 is then transmitted to the proxy server and stored on the proxy server.

In one embodiment, program code 307 for a method for online social activity-driven group gifting is integrated into a client, server and network environment by providing for program code 307 to coexist with software applications (not shown), operating systems (not shown) and network operating systems software (not shown) and then installing program code 307 on the clients and servers in the environment where program code 307 will function.

The first step of the aforementioned integration of code included in program code 307 is to identify any software on the clients and servers, including the network operating system (not shown), where program code 307 will be deployed that are required by program code 307 or that work in conjunction with program code 307. This identified software includes the network operating system, where the network operating system comprises software that enhances a basic operating system by adding networking features. Next, the software applications and version numbers are identified and compared to a list of software applications and correct version numbers that have been tested to work with program code 307. A software application that is missing or that does not match a correct version number is upgraded to the correct version.

A program instruction that passes parameters from program code 307 to a software application is checked to ensure that the instruction's parameter list matches a parameter list required by the program code 307. Conversely, a parameter passed by the software application to program code 307 is checked to ensure that the parameter matches a parameter required by program code 307. The client and server operating systems, including the network operating systems, are identified and compared to a list of operating systems, version numbers, and network software programs that have been tested to work with program code 307. An operating system, version number, or network software program that does not match an entry of the list of tested operating systems and version numbers is upgraded to the listed level on the client computers and upgraded to the listed level on the server computers.

After ensuring that the software, where program code 307 is to be deployed, is at a correct version level that has been tested to work with program code 307, the integration is completed by installing program code 307 on the clients and servers.

Embodiments of the present invention may be implemented as a method performed by a processor of a computer system, as a computer program product, as a computer system, or as a processor-performed process or service for supporting computer infrastructure.

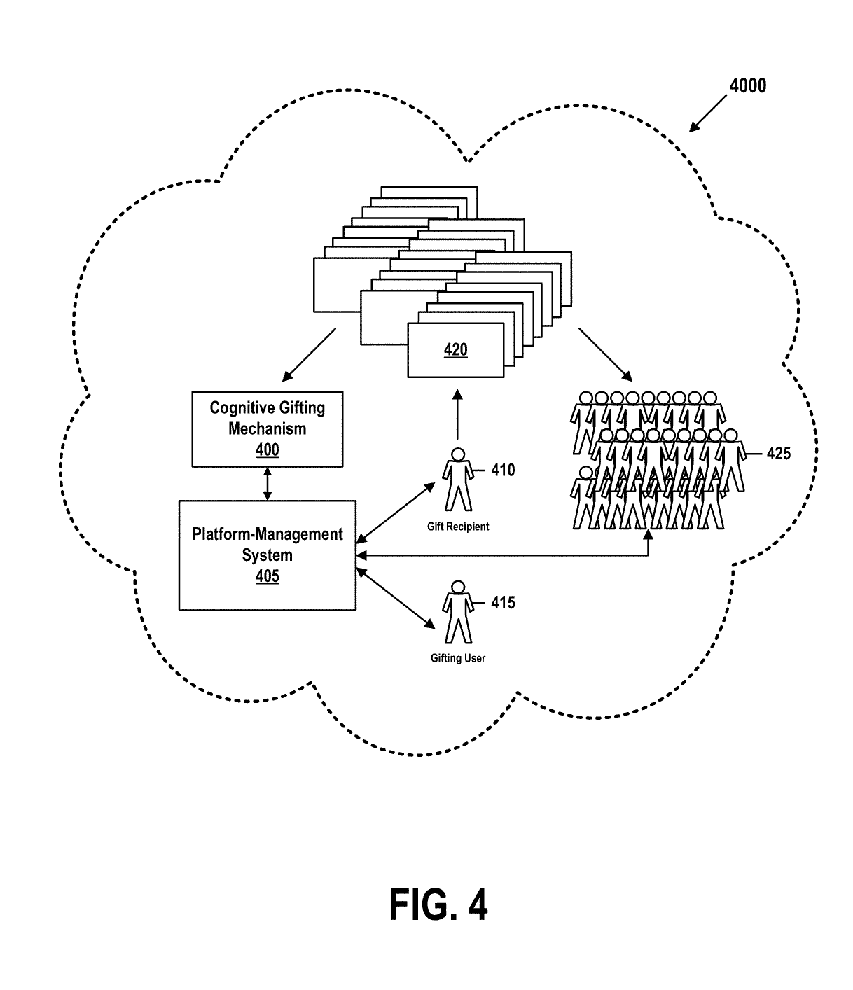

FIG. 4 shows a high-level architecture of an embodiment of the present invention implemented on one or more social-media services or other distributed computing platforms 4000. FIG. 4 comprises items 4000 and 400-425.

The one or more platforms 4000 are each managed by a platform-management system 405. Examples of such platform-management systems 405 are a cloud-management stack of a cloud-computing platform; a distributed transaction-processing application; a user interface of an e-commerce site that allows users to review products, post feedback about purchase experiences, or directly interact with each other; and user-interface and resource-management suite of a social-media service. Certain embodiments may comprise a combination of different types of platforms.

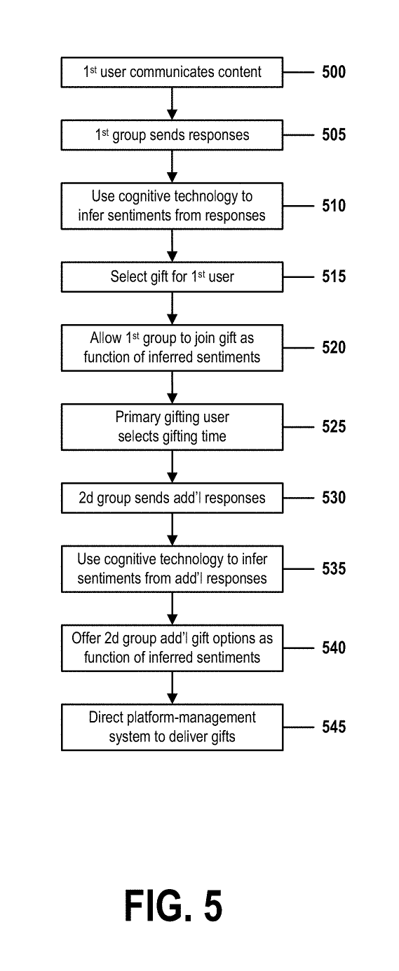

In embodiments described by FIG. 5, platform-management system 405 may comprise or communicate with a cognitive gifting system 400. Gifting system 400 performs operations described by steps of FIG. 5, which include reading and processing certain elements of content 420 posted by users 410, 415, and 425 of distributed computing platforms 4000.

Gifting mechanism 400, as a result of processing elements of content 420, directs the platform-management system 405 to interface directly with a gifting user 415 who may initiate an online gift-giving process, a gift-recipient user 410 who receives the resulting gift through the online gift-giving process, and other users 425 of platforms 4000, who may contribute to the online gift-giving process.

In other embodiments, gifting mechanism 400 may perform steps analogous to those of FIG. 5 by interacting directly with users 410, 415, and 425, rather than by directing platform-management system 405 to do so.

Cognitive gift-giving mechanism 400 thus improves known cloud service offerings, social-media networks, distributed computing environments, collaborative-computing applications, and other multi-user platforms, by providing artificially intelligent group gift-giving functionality. Furthermore, these group gift-giving features may be implemented by means of modular architectures analogous to shown in FIG. 4. In this way, the present invention may improve known multi-user platforms without requiring major alterations to those platforms' existing infrastructure or user interfaces.

FIG. 5 is a flow chart that illustrates steps of a method for online social activity-driven group gifting in accordance with embodiments of the present invention. FIG. 5 shows steps 500-545 which may be performed by embodiments that incorporate the data structures and architecture of FIGS. 3 and 4.

In step 500, a first user 410 posts an initial element of content of the posted content 420 comprised by the one or more distributed computing platforms 4000. This first user 410 will become the recipient of a group gift from gifting user 415 and from other users 425 of platform 4000.

The initial posting may comprise any sort of content that is compliant with platform 4000 and may be posted by any means that makes the posted content visible to other users of platform 4000, such as by posting a political opinion on a social-media site, uploading a video or slideshow to a media-sharing venue, sending transaction-related feedback to an online retailer, or submitting a song review on a musician's fan site. Posted content may also comprise a personal opinion or comment on a personal life event, such as a marriage, anniversary, promotion, birth, retirement, lottery win, business launch, or graduation.

In step 505, a first group of users, comprising a first subset of the other users 425 of platform 4000, post responses to the posted content of recipient user 410. Like the first user's initial posting in step 500, these responsive postings may be posted by any means capable of making the posted content visible to other users of platform 4000.

In step 510, cognitive gifting mechanism 400 detects the first user's initial posting of step 500 and the first group's responsive postings of step 505. Gifting mechanism 400 then uses known methods of cognitive computing, online analytics, or artificial intelligence to perform a sentiment analysis upon the first user's posting and upon each responsive posting. These sentiment analyses each infer one or more elements of emotional subtext from one of the initial or responsive postings.

Gifting mechanism 400 may also perform other types of cognitive analyses or linguistic analyses upon the initial posting and responsive postings, such as a tone analysis that identifies whether a posting has a professional, informal, literate, or other type of stylistic tone, or a personality-trait analysis that identifies relative proportions of various traits of a posting user's personality.

For example, the gifting mechanism 400 in step 510 may determine that the initial posting of gift-recipient first user 410 comprises a wedding announcement. Cognitive analyses of the initial posting infer from the initial posting emotions of happiness, excitement, and anxiety, indicating that the recipient first user 410 is overjoyed about her impending nuptials, but is concerned about its cost.

The gifting mechanism 400 may then apply similar analyses to responsive postings of the first group, inferring that some messages share the first user 410's happiness and excitement, others share her financial concerns, yet others are merely polite, formal responses with little emotional subtext.

In step 515, a personalized gift recommendation is made for gift-recipient first user 410. Some embodiments may require that this recommendation be made in real-time, quickly enough to be viewed by users as an instantaneous or interactive response to user 410's initial posting. Embodiments of the present invention may perform this step in several ways:

i) The gifting mechanism 400 may select a gift as a function of the cognitive analysis of step 510. For example, if the gifting mechanism 400 determines in step 510 that the first user 410's initial posting is a wedding announcement from which may be inferred happiness and anxiety, the gifting mechanism 400 may in response limit gift selection to items commonly associated with wedding gifts. If the gifting mechanism 400 further infers monetary concerns in step 510, then the gifting mechanism 400 may respond by selecting a gift certificate that may be used instead of cash at a home-furnishings store.

In another example, the gifting mechanism in step 400 may determine that a first user 410's initial posting on a streaming-media site describes an illness that will keep the first user bedridden for several weeks, and may infer from the initial posting sentiments of sadness and boredom. In response, the system may select a “cheer-me-up” teddy bear as a gift. If the gifting mechanism 400 further determines from the streaming-media site's user-account information that the first user 410 has subscribed to the site's basic-level media subscription, the gifting mechanism may replace or supplement the teddy bear with a gift subscription to a premium streaming-media subscription.

ii) A second “gifting” user 415 may select the gift. The gifting mechanism 400 may allow gifting user 415 to make this selection as a function of sentiment inferred from the gifting user 415's responsive posting. For example, the gifting mechanism 415 might select one or more candidate gifting users 415 because the inferred sentiments of the responsive content posted by those one or more candidate users 415 are the closest match, or are the most complementary to, sentiment inferred from the recipient user 410's initial posting

In some embodiments, a gifting user 415 may select a gift without authorization of the gifting mechanism 400, and the gifting mechanism 400 may continue to use that gift selection when proceeding through remaining steps of the method of FIG. 5.

iii) The gifting mechanism 400 may select the gift as a function of predefined rules. These rules may be performed as functions of personality traits, sentiments, or other cognitive inferences of step 510, or may merely choose a gift from a list, where that list is selected or configured as a function of a known user characteristic or of a topic of the initial message posted in step 500.

For example, if gift-recipient user 410 in step 500 posted a video clip related to a popular franchise feature film, gifting mechanism 400 might in step 510 select a gift from the five-star products on a Web site that sells collectible merchandise associated with that film. Similarly, if user 410 is enrolled as a member of a coffee-aficionado group on social-media platform 4000 or has subscribed to user channels of social-media platform 4000 that are related to coffee roasting and brewing, then the gifting mechanism 400 might automatically select a gift from a list of coffee-related products. In yet another example, gifting mechanism 400 may automatically select a popular new-music release for all recipients 410 who are in a certain age group, who posted initial content from which was inferred a “melancholy” sentiment, or who have been characterized by an inferred “introverted” personality trait.

iv) The second gifting user 415 may delegate gift selection to a third user. The third user may be selected by gifting user 415, or may be selected by gifting mechanism 400 as a function of a result of an analysis of step 510 upon a responsive posting of the third user, a predetermined rule, or information about the third user provided by platform 4000. For example, the gifting user 415 may delegate gift selection to a third user who is known to be a close family member of recipient user 410. In another example, gifting mechanism 400 may identify a set of candidate third users by comparing results of sentiment analyses performed upon the candidate third users' responsive postings (or upon their prior postings) to either the responsive posting of the gifting second user 415 or to the initial posting of the recipient first user 410.

Any of these methods may be combined with other features into more complex or flexible gift-selection methods. For example, gifting mechanism 400 may select a gift by means of cognitive inferences, where the cognitive selection is limited by predefined non-cognitive rules that constrain the total cost of the gift, that require the gift to be non-alcoholic, or that limit the gift to digital media. In another example, gifting mechanism 400 may allow a gifting user 415 to select a gift from a limited list compiled by the gifting mechanism 400 from cognitive inferences or predefined rules, or the gifting mechanism 400 may reserve the right to confirm gifting user 415's selection before accepting user 415's selection.

Furthermore, some embodiments may allow the selected gift to comprise multiple gifts, and a different combination of selection methods may be used to select each gift. Similarly, if several distinct groups of similar inferences may be inferred from the responses sent in 505, some embodiments may select a distinct gift for each distinct subgroup of responding users, as a function of each specific cognitive inferences associated with each subgroup.

Embodiments of the present invention may comprise other types of selection criteria when selecting a gift. For example, if all gift-givers share a same characteristic, such as being sports-car fans, the gifting mechanism 400 may be more likely to select a gift that has a more meaningful automotive theme. Gifting users may also be allowed to select alternative gifts, based on giver-defined dependencies. For example, if a financially constrained gift-giver would like to select an expensive floral arrangement, the giver might be allowed to specify either the arrangement or a less-expensive box of chocolates, depending on how many other givers agree to share the cost of the floral arrangement. In this case, if an insufficient number of gift-givers join the floral-arrangement gift, the financially constrained gift-giver's gift selection would default to the chocolates.

In some embodiments, the cognitive gifting mechanism 400 may select a gift based on inferences of contrary or humorous sentiments. For example, if certain respondents responded in step 505 to a marriage-anniversary posting of recipient 410 with humorous, teasing, or ironic messages, a joke gift might be selected, or might be added to a primary gift, such as a novelty “ball and chain” keychain.

In step 520, gifting system 400 invites members of the first group who responded to the initial posting of gift-recipient 410 in step 505 to contribute to the selected gift. In some embodiments, gifting mechanism 400 will invite any user who responded in step 505, but in other embodiments, invitations will be sent to only those users whose responses comprise inferred sentiment similar to that of recipient user 410 or gifting user 415.

These invitations may be sent by any means available to users 425 of platform 4000, such as by directing platform-management system 405 to send solicitations to selected members of the users 425 of platform 4000. The invitations may comprise any information deemed necessary to facilitate a gifting decision, such as information about the recipient or about the gift, terms of a gifting mechanism, or a link to a more detailed description of the gift.

Members that accept a solicitation may respond by any means available to users of platform 4000, including the platform 4000's normal modes of communication between users and platform-management system 405. In one example, a user may be allowed to join a collaborative gift by simply clicking a “Join” button.

Platform-management system 405 may, in collaboration with gifting mechanism 400, determine a tentative amount to be contributed by each gifting user in the first group. As will be described below, if the total number of gifting users changes prior to the sending of the gift, the amount of contribution of each gifting user will be automatically adjusted. Each contributed amount may comprise real or virtual currency, reward points or other incentives, user status-based privileges, mileage awards, or any other resource of value to users of platform 4000.

In step 525, the cognitive gifting mechanism 400 or the primary gifting user 415 selects a time at which the gift will be sent to recipient 410. A future gifting time may be selected in this step in order to give other users additional time to join the contributing group.

In some embodiments, if an immediate delivery is selected, certain subsequent steps of FIG. 5 may be omitted and the method of FIG. 5 will terminate as soon as gifting mechanism 400 directs platform-management system 405 to deliver the selected gift and to invoice or collect contributions from users who had joined the gift. In other embodiments, however, if additional users wish to gift recipient user 410 after the gift has already been delivered, subsequent steps of FIG. 5 described below may give those additional users other gift-giving options.

In step 530, a second subset of platform 4000's users 425 continues to post responses to the initial posting of step 500. These additional responses may be sent and received in a manner similar to that of responses received in step 505, and may contain content similar to that of responses received in step 505.

In step 535, the cognitive gifting mechanism 400 detects the second subset's additional responsive postings of step 535. Gifting mechanism 400 then uses known cognitive methods similar to those of step 510 to infer sentiment, tone, personality traits, or other semantic content from the additional responsive postings.

In step 540, the cognitive gifting mechanism 400 offers additional gift options to selected members of the second subset. As in step 520, the gifting mechanism 400 may in some embodiments select any second-subset user who responded in step 530, but in other embodiments, invitations will be sent to only those users whose responses comprise inferred sentiment similar to that inferred from postings of recipient user 410 or primary gifting user 415, or inferred from responses posted in step 505 by first-subset users.

If the gift selected in step 515 has not already been sent to recipient user 410, selected members of the second subset may be offered an opportunity to contribute to the gift. If the total number of contributing gift-givers changes, the cognitive gifting mechanism 400 will automatically recompute the amount of individual contribution due from each gift-giver. This may comprise issuing a partial refund to any members of the first subset who had already contributed to the gift. In some embodiments, gift-givers may not all contribute identical, evenly divided amounts. For example, some gift-givers may voluntarily increase the amount of a contribution or may commit to contributing multiple shares. Conversely, other gift-givers may be allowed to donate a smaller amount or to select an arbitrary contribution amount.

If the gift selected in step 515 has already been sent to recipient user 410 (or if the current contributor list can no longer be altered), selected members of the second subset may be offered the opportunity to send a second gift to user 410. If any second-subset members agree to do so, a second gift will be selected and subsequent steps will be performed in a manner analogous to that of steps 515-525. In this case, gifting second user 415 may select the second gift, or a gifting third user, chosen from selected members of the second subset, may select the second gift.

In some embodiments, steps 530-540 may be repeated, each time adding new contributors to an existing gift or selecting another gift for recipient 410.

In step 545, the cognitive gifting mechanism 400, if it has not yet done so already, directs platform-management system 405 to deliver one or more undelivered gifts to recipient user 410. The cognitive gifting mechanism 400, if it has not already done so, will also in this step: invoice all gift-givers of the set of platform users 425 for the amounts of their final contributions; collect any uncollected contributions; or confirm that all the gift-giving users have already satisfied their contribution commitments.

In some embodiments, the cognitive gifting mechanism 400 may itself perform delivery and billing tasks of step 545, rather than directing the platform-management system 405 to do so.

Examples and embodiments of the present invention described in this document have been presented for illustrative purposes. They should not be construed to be exhaustive nor to limit embodiments of the present invention to the examples and embodiments described here. Many other modifications and variations of the present invention that do not depart from the scope and spirit of these examples and embodiments will be apparent to those possessed of ordinary skill in the art. The terminology used in this document was chosen to best explain the principles underlying these examples and embodiments, in order to illustrate practical applications and technical improvements of the present invention over known technologies and products, and to enable readers of ordinary skill in the art to better understand the examples and embodiments disclosed here.

What is claimed is:

1. An online gifting system comprising a processor, a memory coupled to the processor, and a computer-readable hardware storage device coupled to the processor, the storage device containing program code configured to be run by the processor via the memory to implement a method for online social activity-driven group gifting, the method comprising:
receiving notice, by the gifting system, that a first user of an online community has posted an initial posting to other users of the online community;
detecting, by the gifting system, that a first group of users of the online community have posted responsive postings to the first user's initial posting;
conducting, by the gifting system, a set of cognitive analyses, where the set of cognitive analyses comprises a sentiment analysis of the initial posting and a sentiment analysis of each of the responsive postings;
selecting, by the gifting system, a first gift as a function of the conducting;
choosing, by the gifting system, a subset of the first group;
inviting, by the gifting system, each member of the chosen subset to contribute to the first gift;
receiving, by the gifting system, a contribution to the first gift from at least one of the invited members; and
delivering the first gift to the first user, by the gifting system, in the name of the contributing members.

2. The system of claim 1, where each sentiment analysis of the set of cognitive analyses uses a method of artificial intelligence to infer an emotional subtext of a posting.

3. The system of claim 1,
where the set of cognitive analyses further comprises a personality analysis of the initial posting and a personality analysis of each responsive posting, and
where each personality analysis of the set of cognitive analyses uses a method of artificial intelligence to infer a personality trait of a user who posted the analyzed posting.

4. The system of claim 1, where the selecting the first gift further comprises:
selecting, by the gifting system, a gifting user as a function of the conducting; and
receiving, by the gifting system, a gift selection from the gifting user.

5. The system of claim 1, where a first member of the first group is chosen for the subset if the sentiment analysis of the initial posting and the sentiment analysis of the responsive posting of the first member both identify a same sentiment.

6. The system of claim 1, further comprising:
detecting, by the gifting system, that a second group of users of the online community have posted responsive postings to the first user's initial posting;
determining, by the gifting system, that it is possible to add additional contributors to the first gift;
conducting, by the gifting system, a second set of cognitive analyses, where the second set of cognitive analyses comprises a sentiment analysis of each responsive posting of the second group;
choosing, by the gifting system, a subset of the second group as a function of the second set of cognitive analyses;
inviting, by the gifting system, each member of the subset of the second group to contribute to the first gift;
receiving, by the gifting system, a contribution to the first gift from at least one of the invited members of the second group; and
adding, by the gifting system, the names of the contributing members of the second group to the list of contributors in whose name the first gift is delivered.

7. The system of claim 1, further comprising:
detecting, by the gifting system, that a second group of users of the online community have posted responsive postings to the first user's initial posting;
determining, by the gifting system, that it is no longer possible to add additional contributors to the first gift;
conducting, by the gifting system, a second set of cognitive analyses, where the second set of cognitive analyses comprises a sentiment analysis of each responsive posting of the second group;
choosing, by the gifting system, a subset of the second group as a function of the second set of cognitive analyses,
selecting, by the gifting system, a second gift as a function of the second set of cognitive analyses;
inviting, by the gifting system, each member of the subset of the second group to contribute to the second gift;
receiving, by the gifting system, a contribution to the second gift from at least one of the invited members of the second group; and
delivering the second gift to the second user, by the gifting system, in the name of the contributing members of the second group.

8. A method for online social activity-driven group gifting, the method comprising:
an online gifting system receiving notice that a first user of an online community has posted an initial posting to other users of the online community;
the online gifting system detecting that a first group of users of the online community have posted responsive postings to the first user's initial posting;
the online gifting system conducting a set of cognitive analyses, where the set of cognitive analyses comprises a sentiment analysis of the initial posting and a sentiment analysis of each of the responsive postings;
the online gifting system selecting a first gift as a function of the conducting;
the online gifting system choosing a subset of the first group;
the online gifting system inviting each member of the chosen subset to contribute to the first gift;
the online gifting system receiving a contribution to the first gift from at least one of the invited members; and
the online gifting system delivering the first gift to the first user in the name of the contributing members.

9. The method of claim 8,
where the set of cognitive analyses further comprises a personality analysis of the initial posting and a personality analysis of each responsive posting, and
where each personality analysis of the set of cognitive analyses uses a method of artificial intelligence to infer a personality trait of a user who posted the analyzed posting.

10. The method of claim 8, where the selecting the first gift further comprises:
the online gifting system selecting a gifting user as a function of the conducting; and
the online gifting system receiving a gift selection from the gifting user.

11. The method of claim 8, where a first member of the first group is chosen for the subset if the sentiment analysis of the initial posting and the sentiment analysis of the responsive posting of the first member both identify a same sentiment.

12. The method of claim 8, further comprising:
the online gifting system detecting that a second group of users of the online community have posted responsive postings to the first user's initial posting;
the online gifting system determining that it is possible to add additional contributors to the first gift;
the online gifting system conducting a second set of cognitive analyses, where the second set of cognitive analyses comprises a sentiment analysis of each responsive posting of the second group;
the online gifting system choosing a subset of the second group as a function of the second set of cognitive analyses;
the online gifting system inviting each member of the subset of the second group to contribute to the first gift;
the online gifting system receiving a contribution to the first gift from at least one of the invited members of the second group; and
the online gifting system adding the names of the contributing members of the second group to the list of contributors in whose name the first gift is delivered.

13. The method of claim 8, further comprising:
the online gifting system detecting that a second group of users of the online community have posted responsive postings to the first user's initial posting;
the online gifting system determining that it is no longer possible to add additional contributors to the first gift;
the online gifting system conducting a second set of cognitive analyses, where the second set of cognitive analyses comprises a sentiment analysis of each responsive posting of the second group;
the online gifting system choosing a subset of the second group as a function of the second set of cognitive analyses;
the online gifting system selecting a second gift as a function of the second set of cognitive analyses;
the online gifting system inviting each member of the subset of the second group to contribute to the second gift;
the online gifting system receiving a contribution to the second gift from at least one of the invited members of the second group; and
the online gifting system delivering the second gift to the second user in the name of the contributing members of the second group.

14. The method of claim 8, further comprising providing at least one support service for at least one of creating, integrating, hosting, maintaining, and deploying computer-readable program code in the computer system, wherein the computer-readable program code in combination with the computer system is configured to implement the receiving notice, the detecting, the conducting, the selecting, the choosing, the inviting, the receiving a contribution, and the delivering.

15. A computer program product, comprising a computer-readable hardware storage device having a computer-readable program code stored therein, the program code configured to be executed by an online gifting system comprising a processor, a memory coupled to the processor, and a computer-readable hardware storage device coupled to the processor, the storage device containing program code configured to be run by the processor via the memory to implement a method for online social activity-driven group gifting, the method comprising:
receiving notice, by the gifting system, that a first user of an online community has posted an initial posting to other users of the online community;
detecting, by the gifting system, that a first group of users of the online community have posted responsive postings to the first user's initial posting;
conducting, by the gifting system, a set of cognitive analyses, where the set of cognitive analyses comprises a sentiment analysis of the initial posting and a sentiment analysis of each of the responsive postings;
selecting, by the gifting system, a first gift as a function of the conducting;
choosing, by the gifting system, a subset of the first group;
inviting, by the gifting system, each member of the chosen subset to contribute to the first gift;
receiving, by the gifting system, a contribution to the first gift from at least one of the invited members; and
delivering the first gift to the first user, by the gifting system, in the name of the contributing members.

16. The computer program product of claim 15,
where the set of cognitive analyses further comprises a personality analysis of the initial posting and a personality analysis of each responsive posting, and
where each personality analysis of the set of cognitive analyses uses a method of artificial intelligence to infer a personality trait of a user who posted the analyzed posting.

17. The computer program product of claim 15, where the selecting the first gift further comprises:
selecting, by the gifting system, a gifting user as a function of the conducting; and
receiving, by the gifting system, a gift selection from the gifting user.

18. The computer program product of claim 15, where a first member of the first group is chosen for the subset if the sentiment analysis of the initial posting and the sentiment analysis of the responsive posting of the first member both identify a same sentiment.

19. The computer program product of claim 15, further comprising:
detecting, by the gifting system, that a second group of users of the online community have posted responsive postings to the first user's initial posting;
determining, by the gifting system, that it is possible to add additional contributors to the first gift;
conducting, by the gifting system, a second set of cognitive analyses, where the second set of cognitive analyses comprises a sentiment analysis of each responsive posting of the second group;
choosing, by the gifting system, a subset of the second group as a function of the second set of cognitive analyses;
inviting, by the gifting system, each member of the subset of the second group to contribute to the first gift;
receiving, by the gifting system, a contribution to the first gift from at least one of the invited members of the second group; and
adding, by the gifting system, the names of the contributing members of the second group to the list of contributors in whose name the first gift is delivered.

20. The computer program product of claim 15, further comprising:
detecting, by the gifting system, that a second group of users of the online community have posted responsive postings to the first user's initial posting;
determining, by the gifting system, that it is no longer possible to add additional contributors to the first gift;
conducting, by the gifting system, a second set of cognitive analyses, where the second set of cognitive analyses comprises a sentiment analysis of each responsive posting of the second group;
choosing, by the gifting system, a subset of the second group as a function of the second set of cognitive analyses;
selecting, by the gifting system, a second gift as a function of the second set of cognitive analyses;
inviting, by the gifting system, each member of the subset of the second group to contribute to the second gift;
receiving, by the gifting system, a contribution to the second gift from at least one of the invited members of the second group; and
delivering the second gift to the second user, by the gifting system, in the name of the contributing members of the second group.
